(19) United States
(12) Patent Application Publication
(10) Pub. No.: US 2023/0180918 A1
(43) Pub. Date: Jun. 15, 2023

(54) LIFT BELT

(71) Applicant: JJK Enterprises Inc., Manasquan, NJ (US)

(72) Inventor: Keith Robert KENNEDY, Point Pleasant, NJ (US)

(21) Appl. No.: 17/549,715

(22) Filed: Dec. 13, 2021

(51) Int. Cl. A45F 3/14; B65G 7/12

(52) U.S. Cl. CPC A45F 3/14; B65G 7/12; A45F 2003/144; A45F 2003/142

(57) ABSTRACT

A lift belt for supporting loads carried by a user. The lift belt includes a tray and a harness. The tray includes a body including an upper end and a lower end. The tray further includes a shelf attached to the body at the upper end of the body. The harness is connectable to the tray in two locations configured to vertically support loads disposed on the shelf and two locations configured to horizontally secure the tray to the user.

### BACKGROUND

### Field

Embodiments of the present disclosure generally relate to a lift belt.

### Description of Related Art

Conventional lift belts may be worn by workers to transport goods, such as articles in boxes, about a warehouse. These conventional lift belts may include a tray with a shelf to place boxes thereon, but the upper surface of the shelf is partially obstructed by a body of the above the shelf. Additionally, conventional lift belts are not attachable to a container that can be supported on the shelf.

There is a need in the art for an improved lift belt with a shelf unobstructed by the body of the tray. There is also a need in the art for a lift belt with an attachable container.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a perspective view of a lift belt worn by a person.

FIGS. 2A-2F illustrate a tray of the lift belt. FIG. 2A is a front view of the tray. FIG. 2B is a rear view of the tray. FIG. 2C is a side view of the tray with the body belt and suspension belts omitted. FIG. 2D is a bottom perspective view of the tray with the body belt and suspension belts omitted. FIG. 2E is a rear view of the tray with the body belt, suspension belts, and removable back portion omitted. FIG. 2F is a top perspective view of the tray with the body belt and suspension belts omitted.

FIGS. 3A-3B illustrate a container of the lift belt. FIG. 3A is a side view of the container. FIG. 3B is a bottom view of the container.

FIG. 4 is a rear view of a harness of the lift belt.

FIGS. 5A-5B are schematic partial side views of a lock securing the container to the tray.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

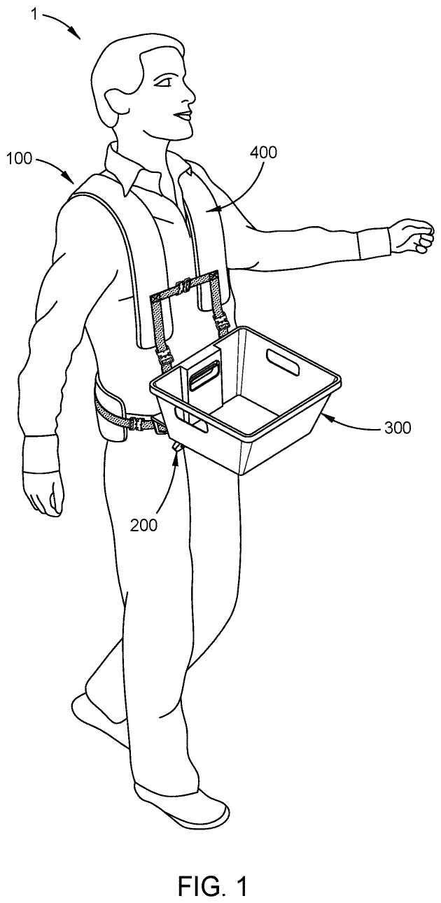

FIG. 1 illustrates a lift belt 100 that includes a tray 200 and a harness 400. An optional container 300 may be removably secured to the tray 200. The lift belt 100 may be worn by a person 1. For example, the lift belt 100 may be worn by a worker in a warehouse to support loads, such as boxes and the like.

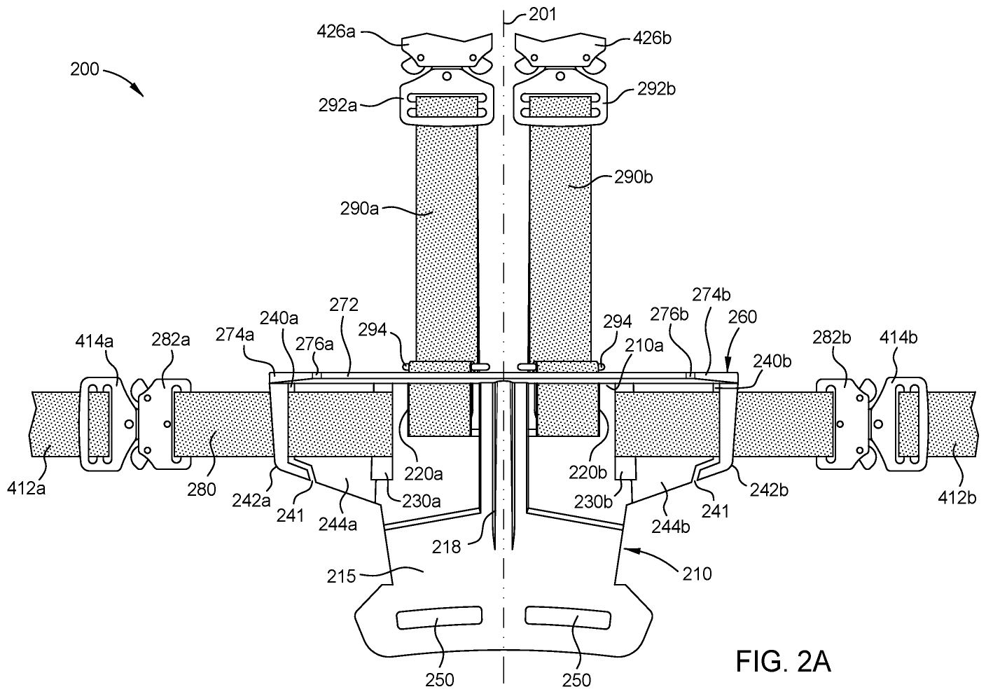

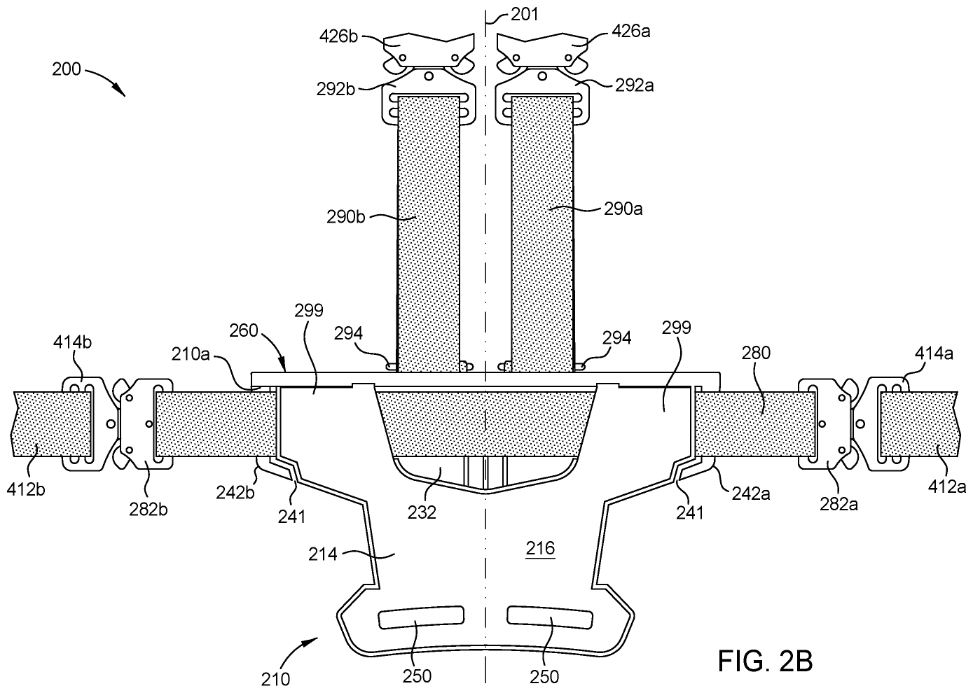

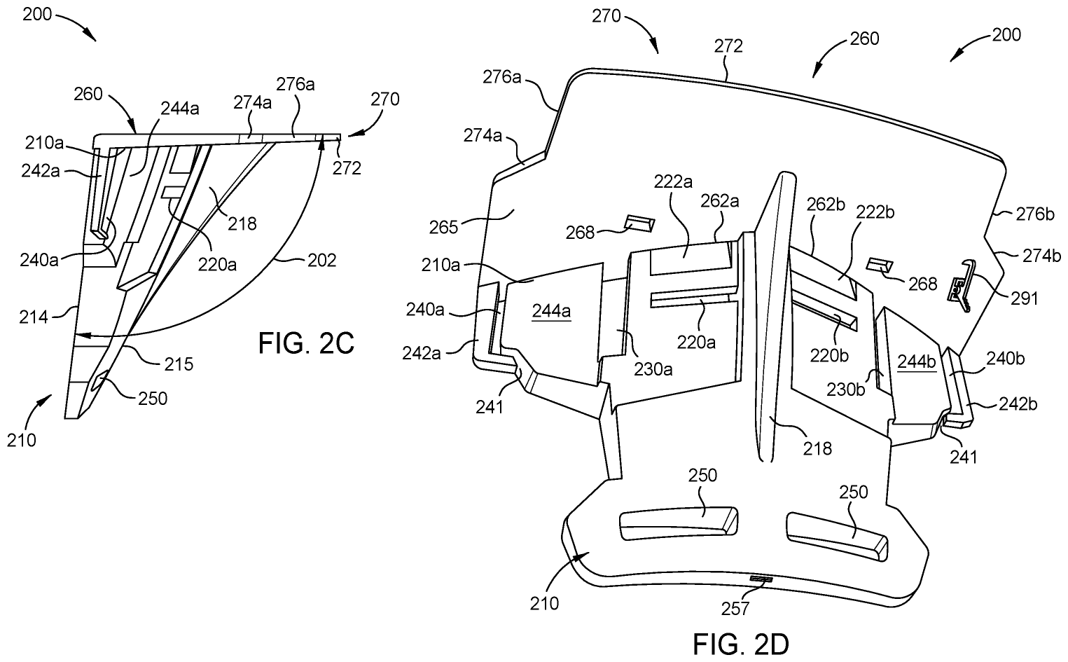

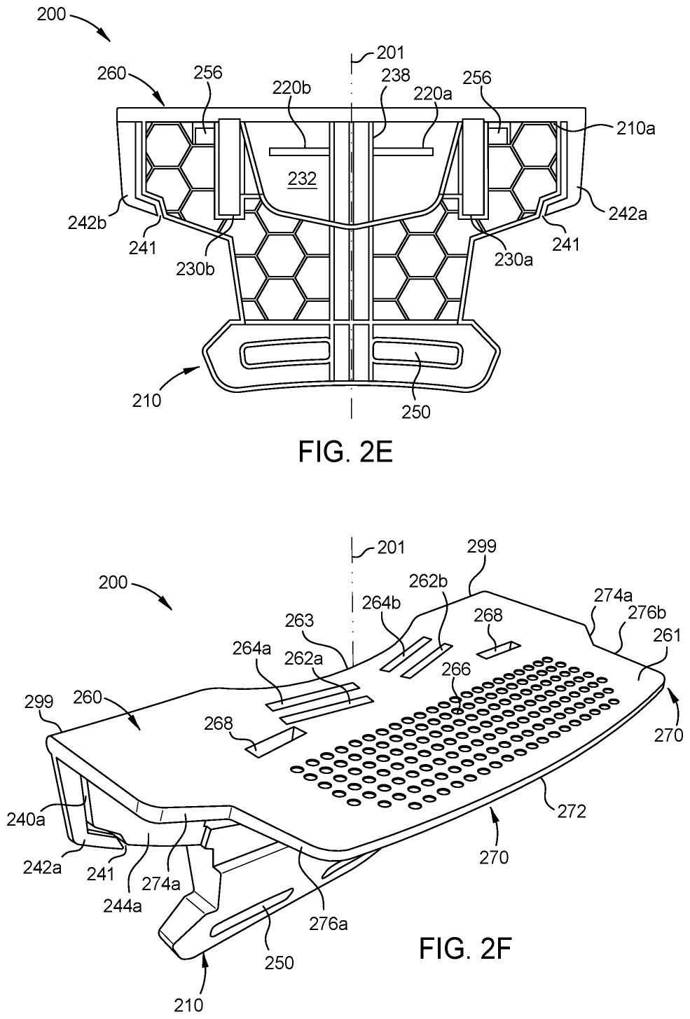

FIGS. 2A-2F Illustrate the tray 200. FIG. 2A illustrates the front side of the tray 200 and FIG. 2B illustrates the back side of the tray 200. The tray 200 includes a body 210, a shelf 260, a body belt 280, and a first and second suspension belt 290a,b. The body 210 is below the shelf 260 so that the loads placed on the shelf 260 are supported by the body 210 being urged against the lower torso and/or legs of the person wearing the lift belt 100. In some embodiments, the body 210 and the shelf 260 are rigidly connected such as being integral with one another or attached together by one or more fasteners. The shelf 260 is connected to the upper end 210a of the body 210. As shown in FIG. 2C, the body 210 is at an angle 202 relative to the shelf 206. The angle 202 may be between 60 and 120 degrees, such as greater than 90 degrees. In another example, the angle 202 is within about plus or minus 15 degrees of 90 degrees. In some embodiments, and as shown in FIG. 2D, the body 210 is longer than the shelf 260, which distributes the load supported on the shelf 260 over a larger area of the inner surface 214 of the body 210.

The front side of the body 210 includes an outer surface 215 as shown in FIG. 2A. The back side of the body 210 includes an inner surface 214 as shown in FIG. 2B, and the inner surface 214 is on the opposite side of the body 210 as the outer surface 215. The inner surface 214 may be curved to conform to the abdominal and/or pelvic regions of a person wearing the lift belt 100. In one example, the inner surface 214 is a concave surface. The body 210 may include a brace 218, such as a gusset, disposed on or integral with the outer surface 215 to support the shelf 260.

The body 210 further includes inner slots 220a,b, middle slots 230a,b, and outer slots 240a,b. The first inner slot 220a may be located on a different side of the brace 218 than the second inner slot 220b as shown in FIG. 2A, such as on opposing sides of the centerline 201 of the tray 200. The first middle slot 230a is disposed between the first outer slot 240a and the first inner slot 220a, and the second middle slot 230b is disposed between the second outer slot 240b and the second inner slot 220b. The outer slots 240a,b may be open ended slots with openings 241 to allow the belt 280 to be more easily connected and removed from the tray 200. The outer slots 240a,b may be at least partially defined by a respective bracket 242a,b located at opposing ends of the body 210.

FIGS. 2C and 2D illustrates the tray 200 with the body belt 280 and the first and second suspension belts 290a,b omitted to better illustrate the inner slots 220a,b, the middle slots 230a,b, and the outer slots 240a,b. In example, the outer surface 215 may include a tapered surface 222a,b between the shelf 260 and a respective inner slot 220a,b to guide a respective suspension belt 290a,b into a respective front slot 262a,b formed in the shelf 260. The outer surface 215 may include a tapered surface 244a,b between each respective middle slot 230a,b and outer slot 240a,b. The tapered surfaces 244a,b may be engaged with the belt 280 when the belt 280 is connected to the body 210.

In some embodiments, and as shown in FIG. 2B, the back side of the body 210 includes a removable back portion 216. The removable back portion 216 may include one or more tabs (not shown) and a tongue (not shown). The removable back portion 216 may be attached to the body 210 by engaging the tabs with a corresponding tab profile 256 of the body 210 and further engaging the tongue with a groove 257 of the body 210. In some embodiments, the removable back portion 216 may be attached by one or more fasteners. In some embodiments, the body 210 does not include a removable back portion 216.

The body 210 may include a cavity 232 as shown in FIG. 2E. FIG. 2E illustrates the tray 200 with the removable back portion 216 and body belt 280 removed to better illustrate the cavity 232. The cavity 232 may be a recessed portion of the body 210. The cavity 232 is connected to the middle slots 230a,b at each end of the cavity 232. The inner slots 220a,b are also connected to the cavity 232. The cavity 232 is further connected to the back slots 264a,b formed in the shelf 260. The cavity 232 provides access to the rear side of the middle slots 230a,b to facilitate the connection of the belt 280 to the body 210. The cavity 232 also provides access to the rear side of the inner slots 220a,b and the bottom side of each back slot 264a,b to facilitate the connection of each suspension belt 290a,b to the body 210 and the shelf 260. The cavity 232 may be bounded in part by the shelf 260. A brace 238, such as a gusset or plurality of ribs, may be disposed in the cavity 232 on the opposite side of the body from the brace 218. The brace 218 and brace 238 provide a rigid structure to support the shelf 260 such that the shelf does not deflect under a load supported on the shelf 260. In some embodiments, the brace 238 is part of the brace 218. The brace 218 and the brace 238 may be symmetrically divided by the centerline 201.

In some embodiments, the body 210 may include one or more attachment slots 250 adjacent to the lower end of the body 210 opposite of the shelf 260. A strap or belt may be looped or otherwise attached to the one or more attachment slots 250 to suspend an object from the one or more attachment slots 250. In some embodiments, a strap or belt may be may be partially disposed between the legs of the wearer and attached to the harness 400 at one end and the one or more slots 250 at the other end.

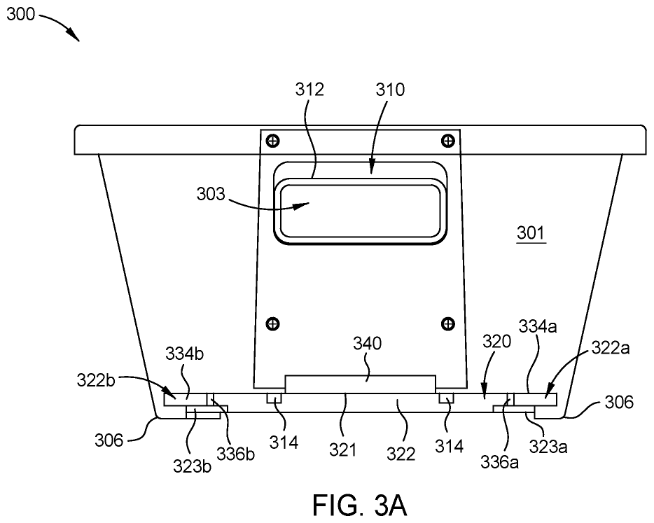

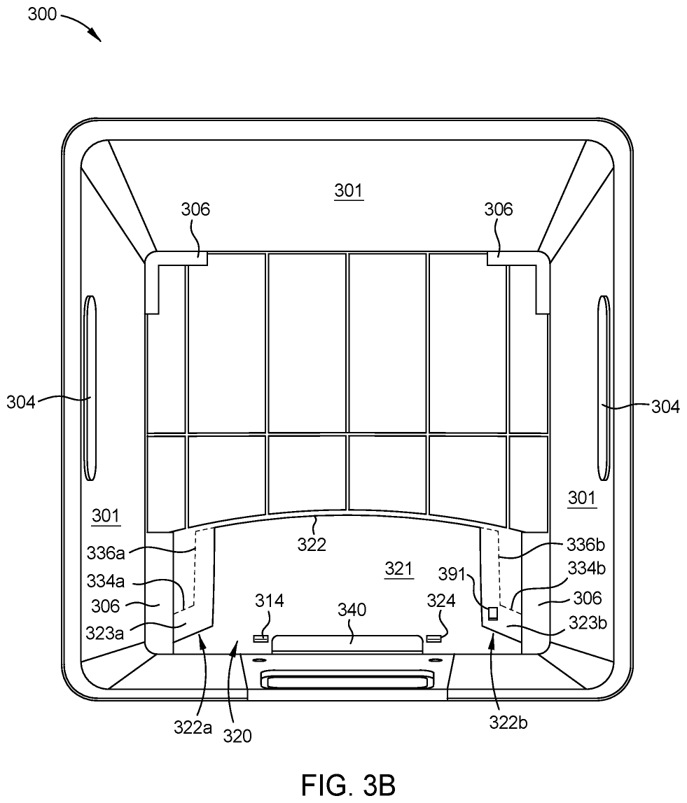

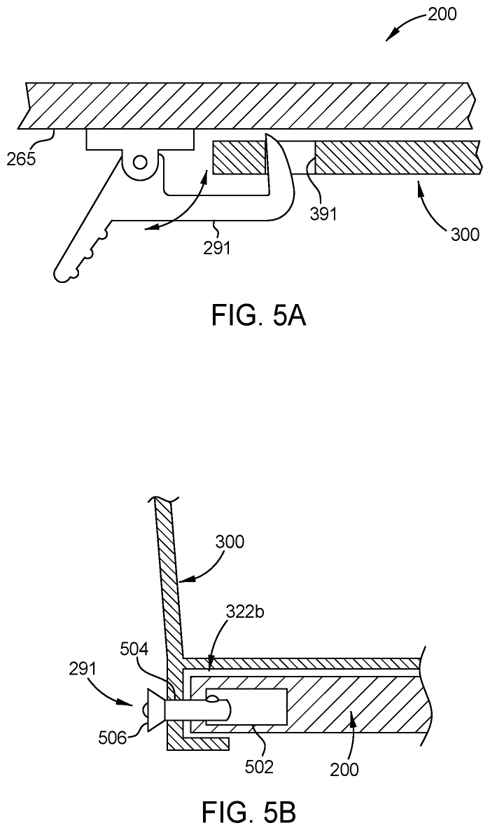

Also depicted in FIG. 2D is a lock 291. The lock 291 is configured to temporarily secure the container 300 to the tray 200 when in a first state (i.e., first or locked position), while allowing the container 300 to be freely removed from the tray 200 when in a second state (i.e., second or unlocked position). The lock 291 may be secured to one of the container 300 or tray 200, and be configured to selectively engage a mating or complimentary feature in the other of the container 300 or tray 200. In the example depicted in FIG. 2D, the lock 291 is shown as a spring latch that functions to engage a complimentary feature 391 (such as a rib, slot or hole (391 as shown FIG. 3B)) of the container 300. FIG. 5A illustrates the lock 291 coupled to the tray 200 and engaging a complimentary feature 391 (shown as a hole) formed in the container 300. Alternatively, the lock 291 may be another type of latch, catch, spring plunger, ball detent, fast pin, clevis pin or other mechanism suitable for temporarily securing the container 300 to the tray 200. For example, FIG. 5B illustrates the lock 291 in the form of a fast pin 506 engaged with aligned holes 502, 504 formed in the tray 200 and the container 300. When the fast pin 506 is removed from the holes 502, 504, the container 300 may be freely removed from the tray 200. Locks 291 of other configurations may alternatively be used to temporarily securing the container 300 to the tray 200.

FIG. 2F is a top perspective view of the shelf 260. The shelf 260 includes an upper surface 261, front slots 262a,b, back slots 264a,b, a gripping surface 266, one or more lock profiles 268, and a tongue profile 270.

The front slots 262a,b and back slots 264a,b are formed in a wall of the shelf 260. Each front slot 262a,b is disposed on an opposing side of centerline 201. Each back slot 264a,b is disposed on an opposing side of the centerline 201. The first front slot 262a is adjacent to the first back slot 264a, and the first front slot 262a is positioned on an opposing side of the body 210 than the first back slot 264a. The second front slot 262b is adjacent to the second back slot 264b, and the second front slot 262b is positioned on an opposing side of the body 210 than the second back slot 264b. The first front slot 262a is aligned with the front side of the first inner slot 220a. The tapered surface 222a is disposed between the first inner slot 220a and the first front slot 262a. The second front slot 262b is aligned with the front side of the second inner slot 220b. The tapered surface 222b is disposed between the second inner slot 220b and the second front slot 262b. The first back slot 264a and second back slot 264b are connected with the cavity 232. The first back slot 264a is aligned with the rear side of the first inner slot 220a. The second back slot 264b is aligned with the rear side of the second inner slot 220b. The front slots 262a,b and the back slots 264a,b may be positioned at an angle relative to the leading tongue profile 270.

The upper surface 261 may be a flat surface and the bottom surface 265 may also be a flat surface parallel to the upper surface 261. The gripping surface 266 may be disposed on or integral with the upper surface 261 of the shelf 260. The gripping surface 266 is configured to prevent objects, such as cardboard boxes, from freely sliding on the shelf 260 when the container 300 is not attached to the tray 200. The gripping surface 266 generally has a high coefficient of friction compared to other areas of upper surface 261. The gripping surface may be a textured surface, a non-skid surface, a plurality of ribs, a plurality of grooves, a polymer pad, and the like. For example, the gripping surface 266 may be a plurality of recessed dimples as shown in FIG. 2F. The tongue profile 270 is configured to engage with a container profile 320 of the container 300. The tongue profile 270 may include a tongue leading edge 272, tongue shoulders 274a,b, and tongue sides 276a,b. The tongue shoulders 274a,b and the tongue sides 276a,b may be tapered. The one or more lock profiles 268 are engageable with a lock 310 of the container 300 to secure the container 300 to the tray 200 once the tongue profile 270 is engaged with the container profile 320. The lock 310 may be a latch, catch, spring plunger, ball detent, fast pin, clevis pin, or other mechanism that releasably secures the container 300 to the tray 200. The shelf 260 may include a recess 263, such as a c-shaped recess as shown in FIG. 2F, along the back edge of the shelf 260. The recess 263 may accommodate a portion of the abdomen of the wearer. Lands 299 on either side of the recess 263 may be configured to rest on the hips of the wearer so the loads supported by the lift belt 100 may be partially transferred to the user's hips.

The tray 200 further includes a body belt 280. FIGS. 2A-2B illustrate the body belt 280, and the body belt 280 has portions engaged with the body 210. The body belt 280 spans the body 210 and is disposed in the cavity 232, the middle slots 230a,b and the outer slots 240a,b. The belt 280 may be engaged with the tapered surfaces 244a,b, the edges of each middle slot 230a,b, the edges of the outer slot 240a,b, the brackets 242a,b, and the brace 238 when connected to the body 210. A buckle portion 282a,b may be attached to each end of the body belt 280. Each buckle portion 282a,b may be the male or female part of a buckle. As shown in FIG. 2A, each buckle portion 282a,b is a female part of a buckle. In some embodiments, one or both of the buckle portions may be a ring, such as a D-ring with a cross-member.

To connect the body belt 280 to the body 210, the belt 280 may first be fed through the opening 241 of the first outer slot 240a to position the first buckle portion 282a to the rear side of the first outer slot 240a. The first outer slot 240a may be sized such that the first buckle portion 282a cannot pass through the first outer slot 240a. The second buckle portion 282b and belt 280 may then be fed over the first tapered surface 244a and then through the first middle slot 230a into the cavity 232 before being further fed though the second middle slot 230b. The second buckle portion 282b and belt 280 may then be fed over the second tapered surface 244b and then through the opening 241 of the second outer slot 240b such that the second buckle portion 282b is positioned to the rear side of the second outer slot 240. The second outer slot 240b may be sized such that the second buckle portion 282b cannot pass through the second outer slot 240b. The belt 280 may be engaged with the brace 238 when connected to the body 210.

The tray 200 further includes a first and second suspension belt 290a,b connected to a corresponding suspension buckle portion 292a,b. A ring 294, such as a D-ring, may be connected to each suspension belt 290a,b. The first suspension belt 290a is looped through the first front slot 262a, the first inner slot 220a, the cavity 232, the first back slot 264a, and the ring 294 to attach the first suspension belt 290a to the tray 200. The second belt 290b is looped through second front slot 262b, second inner slot 220b, the cavity 232, the second back slot 264b, and the ring 294 to attach the second suspension belt 290b to the tray 200. The front slots 262a,b and the back slots 264a,b are sized such that the ring 294 cannot pass through the opening of the slot. The attachment of the two suspension belts 290a,b with their respective buckle portion 292a,b may be adjustable to allow the user to adjust the length of each suspension belt 290a,b. Each suspension belt 290a,b may be pulled tight against the corresponding tapered surface 222a,b.

In some embodiments, the body 210 and the shelf 260 are made of plastic. The plastic body 210 may have a honeycomb and rib structure as shown in FIG. 2E to provide rigidity and strength to the body 210. In some embodiments the body 210 and the shelf 260 may be made of a metal. In some embodiments, the body belt 280 and suspension belts 290a,b may be made of a textile material, such as a synthetic textile. The buckle portions 282a,b, the buckle portions 292a,b, and the ring 294 may be made of a plastic or a metal. The buckle portions 282a,b and buckle portions 292a,b may be part of a quick-release buckle.

FIGS. 3A-3B illustrates the container 300. The container 300 includes a plurality of side walls 301 and a bottom wall 302 that define a storage space 303. One or more walls 301 may include hand holds 304. A plurality of feet 306 may be attached to or integral with the bottom wall 302 to provide stability when the container 300 is placed on a surface, such as a floor or a shelf, when not attached to the tray 200.

The container 300 may optionally include a lock as described above, and in one example includes a lock 310 disposed in one wall 301. The lock 310 may include a handle 312 and one or more locking members 314. To move the lock 310 to an unlocked position, the handle 312 may be pulled by a user to raise the one or more locking members 314 until the locking members 314 retreat into a corresponding lock recess 324 disposed in the bottom wall 302. The lock 310 may be biased toward the locked position by one or more biasing members (not shown) disposed in a wall 301. Once the user releases the handle 312, the biasing members cause the locking members 314 to exit the corresponding lock recess 324 to return the lock 310 to the locked position.

In some embodiments, contact of the locking member 314 with the shelf 260 causes the lock 310 to move to the unlocked position. This contact overcomes the biasing force of the biasing members. The lock 310 returns to the locked position once the lock recess 324 aligns with the lock profile 268 due to the biasing members.

The container 300 further includes a container profile 320 configured to receive the tongue profile 270 of the tray 200. The container profile 320 may be formed in a side wall 301 and the bottom wall 302 as shown in FIG. 3A. The container profile 320 may include a surface 321, grooves 322a,b, and a leading edge shoulder 332.

The surface 321 may be a regions of the outer surface of the bottom wall 302. The one or more lock recesses 324 may be formed in the surface 321. The surface 321 may be engaged with the gripping surface 266 when the container 300 is locked to the tray 200.

Each groove 322a,b may be formed between a corresponding groove wall 323a,b and the surface 321. The grooves 322a,b may be partially formed in a foot 306. Each groove 322a,b may include a corresponding groove shoulder 334a,b and a corresponding side surface 336a,b. Each groove shoulder 334a,b is engageable with a respective tongue shoulder 274a,b and each side surface 336a,b is engageable with a respective tongue side 276a,b when the tongue profile 270 is inserted into the container profile 320. The leading edge shoulder 332 is configured to engage with the tongue leading edge 272 when the tongue profile 270 is inserted into the container profile 320. The leading edge shoulder 332 and the grooves 332a,b may be configured to align the lock profile 268 with a corresponding lock recess 324 when the tongue profile 270 is inserted into the container profile 320.

The container 300 may include a notch 340 adjacent to or contiguous with the container profile 320 to accommodate the rings 294 when the tongue profile 270 is inserted into the container profile 320. The notch 340 may be located between the lock recesses 324.

To attach the container 300 to the tray 200, the tongue profile 270 may be inserted into the container profile 320 while the lock 310 is in the unlocked position. The user may pull the handle 312 to unlock the lock 310 while the tongue profile 270 is inserted into the container profile 320. Once the tongue profile 270 is inserted into the container profile 320, the user may release the handle 312 which will cause the locking members 314 to engage the corresponding lock profile 268 in the shelf 260 to lock the container 300 to the tray 200. In other embodiments, the lock 310 may move to the unlocked position during insertion of the tongue profile 270 due to contact of the locking members 314 with the shelf 260. The lock 310 returns to the locked position once the lock recess 324 aligns with the lock profile 268.

To detach the container 300 from the tray 200, the user pulls the handle 312 to move the lock 310 to the unlocked position. The tongue profile 270 may then be removed from the container profile 320.

In some embodiments, the container 300 includes a lid, such as a hinged or fully detachable lid.

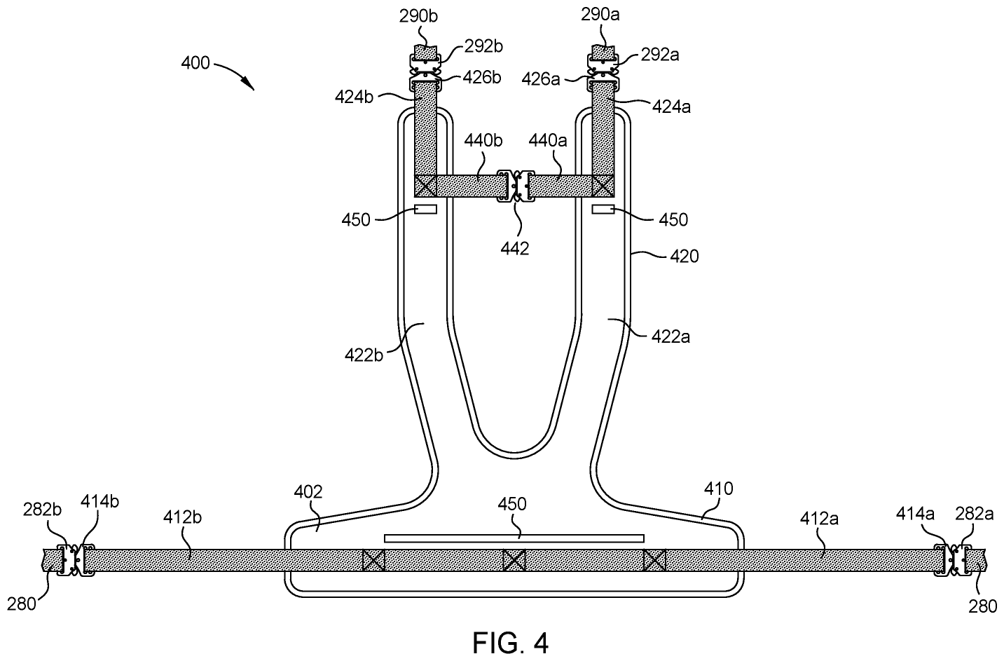

FIG. 4 illustrates the harness 400. The harness 400 includes a body 402 having a back portion 410 and a shoulder portion 420. Although the body 402 is depicted as a unitary structure, the body 402 may comprise multiple separate substructure interconnected by straps or other adjustment devices to provide greater flexibility to fit persons of different sizes or to accommodate objects, such as backpacks, coats and the like, worn under the harness 400. When the harness 400 is worn by a person, the back portion 410 is positioned adjacent the back of the person as shown in FIG. 1. The shoulder portion 420 includes a first shoulder strap 422a and a second shoulder strap 422b. The shoulder straps 422a,b are worn over the shoulder of the person as shown in FIG. 1.

The back portion 410 includes a first waist belt 412a and a second waist belt 412b. A first waist buckle portion 414a is coupled to the first waist belt 412a. A second waist buckle portion 414b is coupled to the second waist belt 412b. The connection between the waist buckle portions 414a,b and its respective waist belt 412a,b may be adjustable to allow the user to increase or decrease the length of a respective waist belt 412a,b. In some embodiments, the first and second waist belts 412a,b are an integral waist belt with an intermediate portion of the waist belt sown onto the back portion 410.

The first shoulder strap 422a includes a first suspension belt 424a. A first suspension buckle portion 426a is coupled to the first suspension belt 424a. A second suspension buckle portion 426b is coupled to the second suspension belt 424b. The connection between the suspension buckle portions 426a,b and its respective suspension belt 424a,b may be adjustable to allow the user to increase or decrease the length of the suspension belt 424a,b.

The first waist buckle portion 414a is connectable to the first buckle portion 282a. The second waist buckle portion 414b is connectable to the second buckle portion 282b. The first suspension buckle portion 426a is connectable with the first buckle portion 292a. The second suspension buckle portion 426b connectable with the second buckle portion 292b.

The waist buckle portions 414a,b and suspension buckle portions 426a,b, may be made of a plastic or a metal. The waist buckle portions 414a,b and suspension buckle portions 426a,b, may be part of a quick-release buckle.

The first shoulder strap 422a may include a first breast belt 440a that is connectable with a second breast belt 440b of the second shoulder strap 422b. The first and second breast belt 440a,b may be connected together by a buckle 442.

One or more reflectors 450 may be disposed on the body 402.

The body 402 may be made of a textile material, such as a synthetic textile.

In some embodiments, the user of the lift belt 100 may lock the container 300 to the tray 200 to carry one or more goods within the storage space 303 of the container 300. In some embodiments, the user may instead carry one or more loads, such as boxes, directly on the shelf 260 in engagement with the gripping surface 266 without the container 300 being attached to the tray 200.

The harness 400 and tray 200 cooperate to support the weight of one or more goods disposed in the container 300 or the weight of one or more goods supported on the shelf 260. The engagement of the inner surface 214 with the abdomen and/or pelvic region of the wearer, the engagement of the back portion 410 with the back of the wearer, and the connection of the waist belts 412a,b with the body belt 280 maintains the tray 200 in an upright position on the wearer as shown in FIG. 1. The connection of the suspension belts 290a,b to the suspension portion 420 supports the weight of any carried goods.

In some embodiments, the lock is disposed on the tray and the lock profile is formed on the container.

While the foregoing is directed to embodiments of the present disclosure, other and further embodiments of the disclosure may be devised without departing from the basic scope thereof, and the scope thereof is determined by the claims that follow.

1. A lift belt for supporting loads carried by a user, the lift belt comprising:
a tray including:
a body including an upper end and a lower end; and
a shelf attached to the body at the upper end of the body, the shelf having an upper surface that includes a gripping surface;
a container having a slot on a bottom of the container sized to removably mate with a profile of the shelf; and
a harness connectable to the tray in two locations configured to vertically support loads disposed on the shelf and two locations configured to horizontally secure the tray to the user.

2. The lift belt of claim 1, wherein the body extends from the shelf a length greater than a length that the shelf extends from the body.

3. (canceled)

4. The lift belt of claim 1, wherein the gripping surface is at least one of a textured surface, a non-skid surface, a plurality of ribs, a plurality of grooves, a polymer pad, or a plurality of recessed dimples.

5. The lift belt of claim 1, wherein the body and the shelf meet to define an angle between 60 and 120 degrees.

6. The lift belt of claim 1, wherein the body and the shelf meet to define an angle greater than 90 degrees.

7. The lift belt of claim 1, wherein the body has an inner surface on an opposing side of the body as an outer surface of the body, and the inner surface is concave.

8. The lift belt of claim 1, wherein the shelf has a tapered portion.

9. (canceled)

10. The lift belt of claim 1, wherein the profile of the shelf includes a leading edge, a first shoulder, and a second shoulder.

11. The lift belt of claim 10, wherein the slot of the container includes a leading edge engageable with a leading edge of the profile of the tray, a first groove configured to receive the first shoulder, and a second groove configured to receive the second shoulder.

12. The lift belt of claim 1, further comprising:
a lock configured to releasably secure the container to the tray.

13. The lift belt of claim 1, wherein the body includes a brace on a front thereof connecting the front of the body to an underside of the shelf.

14. A lift belt for supporting loads carried by a user, the lift belt comprising:
a tray having vertical and horizontal attachment points for securing the tray to a user, the tray comprising:
a body including an upper end and a lower end; and
a shelf attached to the body at the upper end of the body, wherein an upper surface of the shelf includes a gripping surface;
a removable container having a feature configured to matingly engage a complimentary mating feature of the tray; and
a lock configured to selectively secure the removable container to a top surface of the shelf.

15. The lift belt of claim 14, further comprising:
a harness connectable to the tray in two locations configured to vertically support loads disposed on the shelf and two locations configured to horizontally secure the tray to the user.

16. The lift belt of claim 14, wherein the body extends from the shelf a length greater than a length that the shelf extends from the body.

17. (canceled)

18. The lift belt of claim 14, wherein the body and the shelf meet to define an angle between 60 and 120 degrees.

19. The lift belt of claim 14, wherein the body and the shelf meet to define an angle greater than 90 degrees.

20. The lift belt of claim 14, wherein the body has an inner surface on an opposing side of the body as an outer surface of the body, and the inner surface is concave.
